(19) United States
(12) Patent Application Publication
(10) Pub. No.: US 2008/0217876 A1
(43) Pub. Date: Sep. 11, 2008

(54) SYSTEM FOR ADJUSTING A SCREEN

(75) Inventors: Hye S. Chi, Raleigh, NC (US); Robert A. Myers, Cary, NC (US); Robert D. Parsons, Raleigh, NC (US); Jeff D. Thomas, Raleigh, NC (US)

Correspondence Address: SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/125,196

(22) Filed: May 22, 2008

Related U.S. Application Data
(63) Continuation of application No. 10/859,659, filed on Jun. 3, 2004.

(51) Int. Cl. H04N 5/64; B62B 3/14

(52) U.S. Cl. 280/33.991; 348/836; 348/E05.128

(57) ABSTRACT

A display system and computer-readable medium are disclosed. The display system includes a base, a screen movably coupled to the base, and a control unit coupled to the screen. The control unit adjusts the screen to a position based on at least one condition. The at least one condition can be an attribute such as a height or an eye position. According to the system disclosed herein, the display system increases the convenience of a user by automatically adjusting the screen to an optimal position for the user. As a result, improved readability of the screen is achieved while simplifying the use of the display system.

### CROSS-REFERENCE TO RELATED APPLICATIONS

Under 35 USC § 120, this application is a continuation application and claims the benefit of priority to U.S. patent application Ser. No. 10/859,659, filed Jun. 3, 2004, entitled “System and Method for Adjusting a Screen”, all of which is incorporated herein by reference.

### FIELD OF THE INVENTION

The present invention relates to display systems, and more particularly to a system for adjusting a screen.

### BACKGROUND OF THE INVENTION

Display systems enable a user to view information in electronic form. Such display systems can be used on carts such as shopping carts to allow shoppers to view information while shopping and can be used on any system with a screen, e.g., kiosks, automatic teller machines (ATMs), desktop systems, etc. The information can include for example product information, product specials, product locations, etc. A problem with some display systems used with carts is that their screens are mounted on carts in a fixed position. Because different users have varying heights, the screen can be difficult to read.

One solution is to manually adjust the screen so that it is easier to read. However, the user would need to spend time figuring out how to adjust the screen. If too much time is spent adjusting screen or if the screen is not properly adjusted, the shopping experience can be adversely affected. Also, if the adjustment requires an understanding of computers, those without such understanding can have a difficult time adjusting the screen.

Generally, there is not a good solution to this problem today in that the known solutions provide screen that may be hard to read or difficult to adjust. Accordingly, what is needed is an improved system for adjusting a screen. The system should be able to adjust a screen conveniently and should be simple, cost effective, and capable of being easily adapted to existing technology. The present invention addresses such a need.

### SUMMARY OF THE INVENTION

A display system and computer-readable medium are disclosed. The display system comprises a base, a screen movably coupled to the base, and a control unit coupled to the screen. The control unit adjusts the screen to a position based on at least one condition. The at least one condition can be an attribute such as a height or an eye position.

According to the system disclosed herein, the display system increases the convenience of a user by automatically adjusting the screen to an optimal position for the user. As a result, improved readability of the screen is achieved while simplifying the use of the display system.

### BRIEF DESCRIPTION OF THE DRAWINGS

FIG. 1 is a diagram of a conventional display system.

FIG. 2 is a diagram of a display system in accordance with the present invention.

FIG. 3 is a block diagram of a display system, which can be used to implement the display system of FIG. 2 in accordance with the present invention.

FIG. 4 is a flow chart showing an approach for adjusting a screen in accordance with the present invention.

### DETAILED DESCRIPTION

The present invention relates to display systems, and more particularly to a system for adjusting a screen. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A display system is disclosed. The display system comprises a base, a screen movably coupled to the base, and a control unit coupled to the screen. The control unit adjusts the screen to a position based on at least one condition such that the need for a user to manually adjust the screen is eliminated. The at least one condition can be a user attribute such as height or eye position. A sensor can be utilized to detect at least one attribute and transmit the at least one attribute to the control unit. Alternatively, a memory unit can be used to store the at least one attribute and transmit the at least one attribute to the control unit. According to the system disclosed herein, the display system increases the convenience of a user by automatically adjusting the screen to an optimal position for the user. As a result, improved readability of the screen is achieved while simplifying the use of the display system. To more particularly describe the features of the present invention, refer now to the following description in conjunction with the accompanying figures.

In a specific embodiment, the display system is applied to shopping carts and utilized while the user (i.e., the shopper) is shopping. Although the present invention disclosed herein is described in the context of shopping carts, the present invention may apply to other types of mobile units and still remain within the spirit and scope of the present invention.

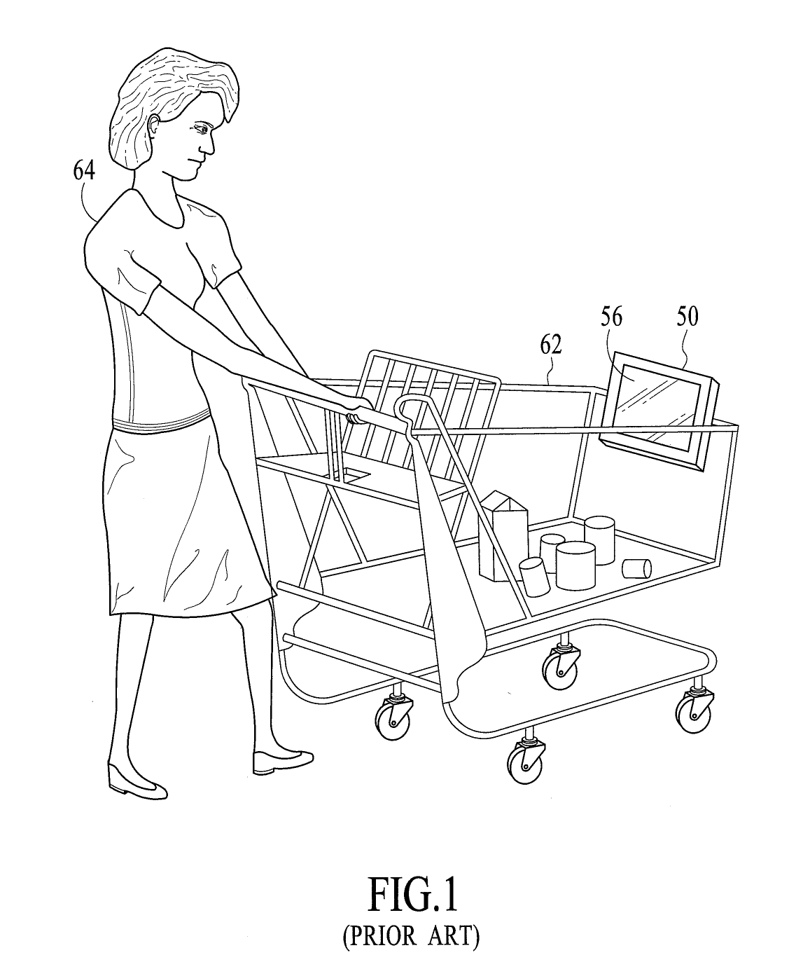

FIG. 1 is a diagram of a conventional display system 50. The display system 50 has a screen 56 and is mounted onto a cart 62, which is pushed by a user 64. As shown, the screen 56 is in a fixed position, which may make the screen 56 difficult to read depending on the height of the user.

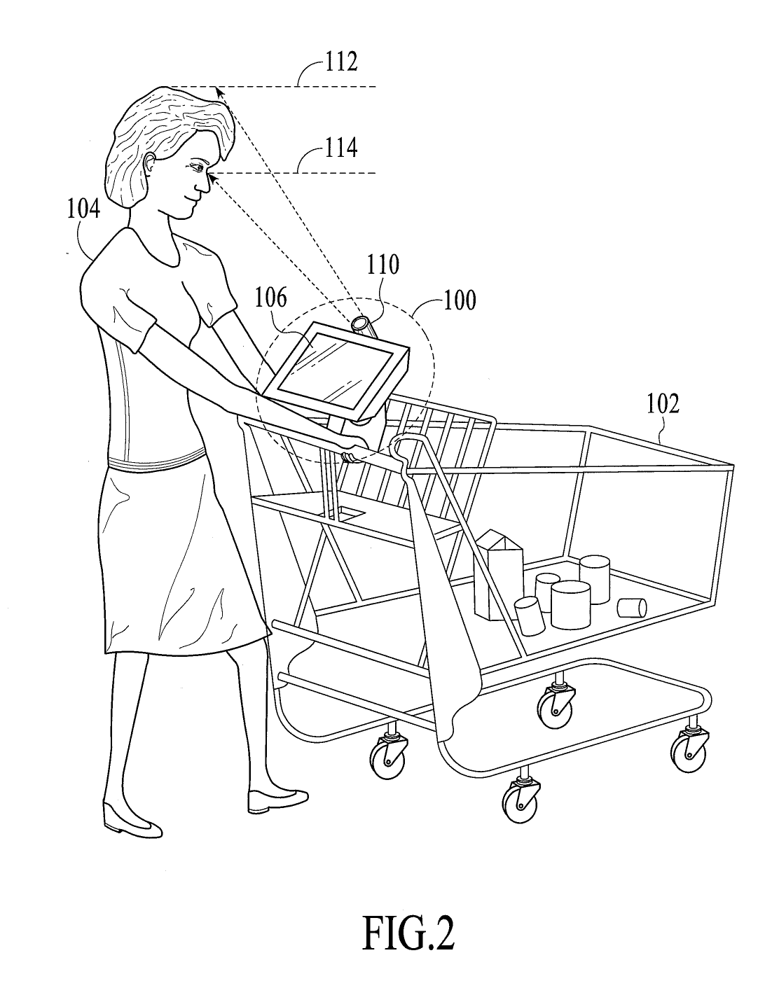

FIG. 2 is a diagram of a display system 100 in accordance with the present invention. The display system 100 is mounted onto a cart 102, which is pushed by a user 104. The display system 100 comprises a screen 106 and a sensor 110 that detects one or more attributes of the user 104. An attribute can be the height 112 or an eye level 114 of the user 104. The screen 106 automatically adjusts to an optimal position for the user 104. A benefit of the display system of the present invention is its hands-free feature. The user 104 does not have to adjust the screen 106 to an optimal position. The screen 106 is automatically adjusted to an optimal position for the user 104. This results in simplicity and convenience of use.

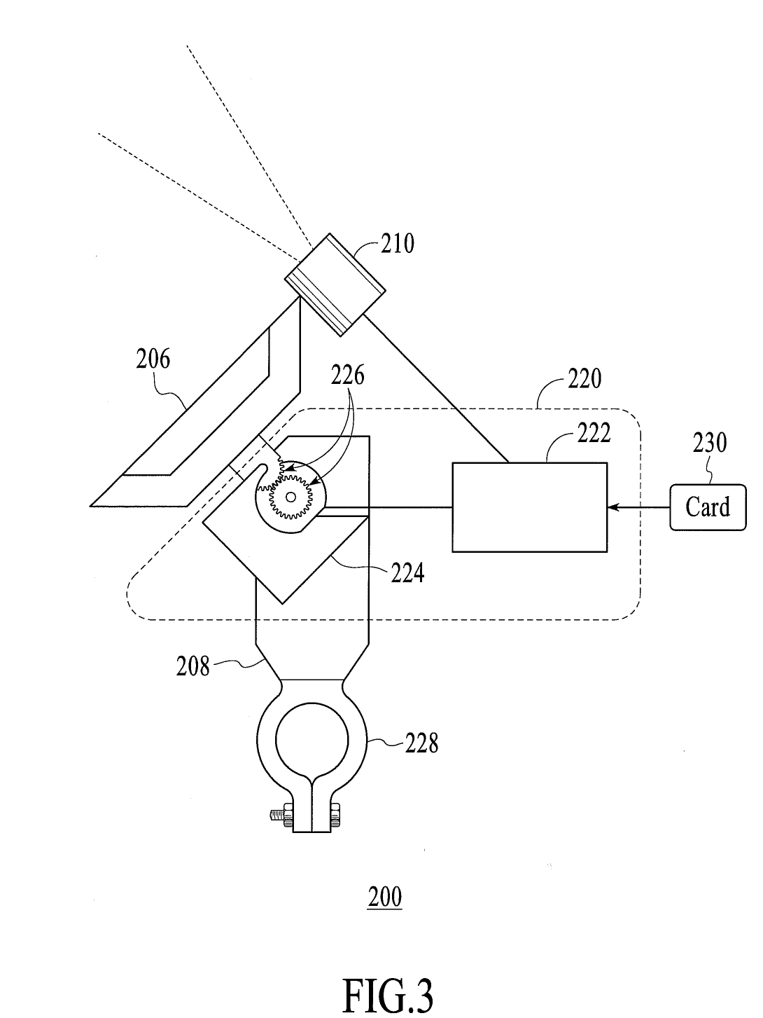

FIG. 3 is a block diagram of a display system 200, which can be used to implement the display system 100 of FIG. 2 in accordance with the present invention. Still referring to FIG. 3, the display system 200 comprises a screen 206 coupled to a base 208, and a sensor 210 coupled to the screen 206. A control unit 220 is coupled to the screen. The control unit 220 adjusts the screen 206 to a position based on at least one condition. The condition can be an attribute such as the height, eye level, or pupil position of the user. By automatically adjusting the screen for the user, the need for the user to manually adjust the screen is eliminated.

The control unit 220 includes a processor 222, a motor 224, and gears 226 that adjust the screen 206 to an optimal position based on a condition. The gears 226 adjust the screen 206 in various ways. For example, the screen can be rotated to the left, to the right, up, down, or any combination thereof. Also, the angle of the screen can be changed. The base includes a mount 228 so that the base can be mounted onto a mobile unit such as a shopping cart. In an alternative embodiment, the base can be integrated with a mobile unit such that the base is the mobile unit.

The sensor 210 detects one or more attributes and transmits information associated with the one or more attributes to the control unit 220. In operation, the sensor 210 detects the presence of an object (i.e., the user) and detects the mass density of the object. The sensor 210 then transmits information associated with the mass density of the object to the processor 222. The processor 222 then utilizes the information associated with the mass density to determine a height value. Alternatively, the sensor 210 can detect an eye level or pupil location of the object and then transmit information associated with the eye level or pupil location to the processor 222. The processor 222 can then utilize the information associated with the eye level or pupil location to determine a height value. Based on the height value, the control unit 220 adjusts the position of the screen 206 to an optimum position for the user.

The specific type of sensor utilized will vary and will depend on the specific application. For example, the sensor can be an optical sensor, a proximity sensor, an ultrasonic sensor, a camera, etc. Also, the specific location of the sensor will depend on the specific application. For example, the sensor can be attached directly to the screen 206, the base 208, or on a mobile unit on which the display system 200 is mounted. In the specific embodiments of FIGS. 2 and 3, the sensor 210 is attached to the top of the screen 206.

In one embodiment, the sensor 210 can be utilized to track a user. This allows the user to move to different locations relative to the cart and still view the screen 206. For example, the user may want to move away from the cart to pick up an item or to look more closely at an item. While away from the cart, the control unit 220 can dynamically adjust the position of the screen 206 so that it tracks or follow the user. This enables the user can view the screen 206 from different locations.

A memory unit 230 can be utilized to store one or more attributes (e.g., height or eye level) and transmit them to the control unit 220. In a specific embodiment, the memory unit 230 is a card such as a shopper loyalty card. The inputting can be accomplished at the display system 200 or at terminals at various store locations. The memory unit 230 can transmit information to the control unit 220 in various ways, depending on the specific embodiment. For example, the memory unit 230 can be inserted into the control unit 210. Alternatively, the memory unit 230 can be swiped through the control unit 210. The swiping process can be done utilizing a magnetic stripe card reader (MSR). After swiping the memory unit 230, the screen 206 is automatically adjusted based on the information stored in the memory unit 230. After the screen 206 is automatically adjusted, the user can further adjust the screen 206. The re-adjusted position of the screen 206 can then be saved on the memory unit 230.

The user can also manually adjust the screen 206 without swiping the memory unit 230. As such, the user can manually enter information (e.g., height) to adjust the screen 206 as desired. If a height is entered, the height can be a height other than the user's actual height. The display system 200 can then store a screen position based on the manually entered information. The display system 200 can then use the new position the next time the memory unit 230 is swiped.

The display system 200 can also reset the screen 206 to a default or “home” position when the display system 200 is not in use, i.e., when the user is finished using the display system 200. The default position can allow carts to be stacked more efficiently even if the display system 200 is left on a cart. This eliminates or minimizes damage to the display system 200.

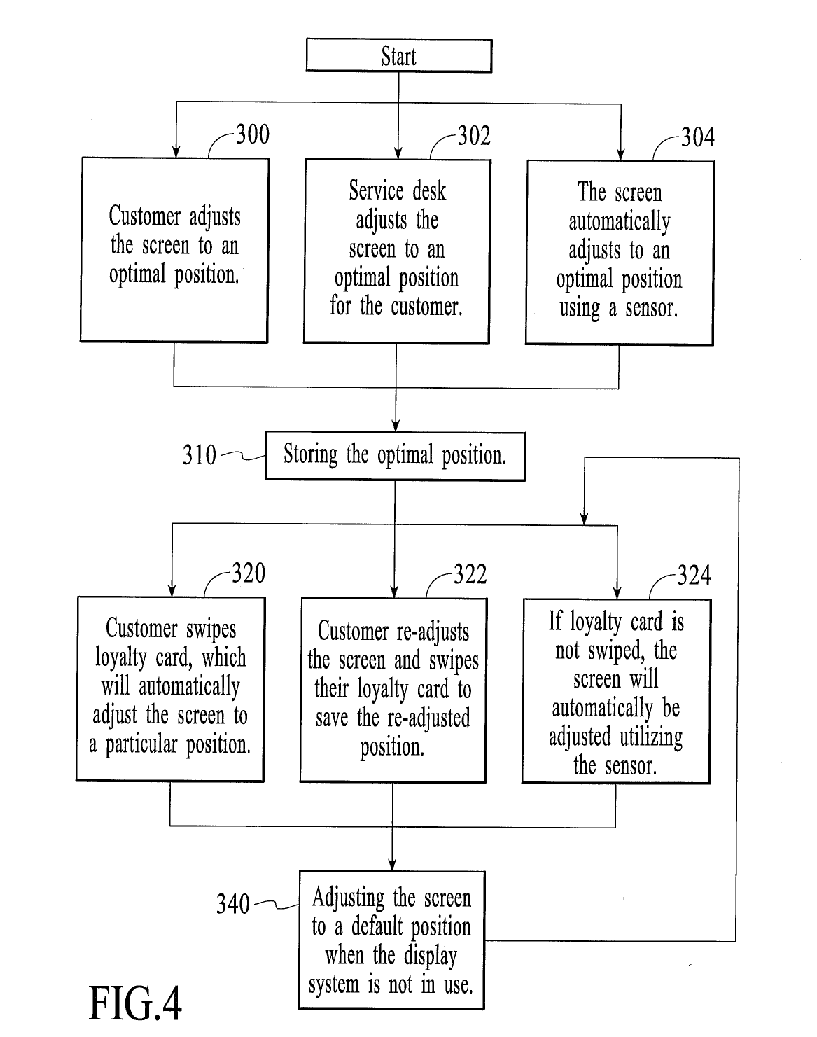

FIG. 4 is a flow chart showing an approach for adjusting a screen in accordance with the present invention. First, upon a first-time usage by the customer, the screen can be adjusted to an optimal position for the user in various ways. The screen can be adjusted by a customer, in a step 300, or by an employee at a service desk, in a step 302. Alternatively, the screen can be automatically adjusted to an optimal position by utilizing a sensor, in a step 304. The adjustment is based on one or more conditions, e.g., attributes such as the height or an eye level of the user. Next, the optimal position is stored in a memory unit. In a specific embodiment, the memory unit can be a card and the card can be swiped through the display system to save the optimal position, in a step 310. Upon a future use, the user can swipe the card through the display system. The screen will then be automatically adjusted based on the information on the card, in a step 320. This information can also be stored at each individual store's databases by remembering customer names, which can be presented through their loyalty shopper cards. Alternatively, the customer can re-adjust the screen and then swipe the card to save the new position, in a step 322. If the card is not swiped, the screen can be automatically adjusted by utilizing a sensor, in a step 324. Finally, when the display system is not in use, the screen can return to a default or “home” state, in a step 340. Alternatively, the screen can be locked into the position based on the information on the card when the display system is not in use.

According to the system disclosed herein, the present invention provides numerous benefits. For example, the display system eliminates the need for a user to manually adjust the screen. The display system increases the convenience of the user by automatically adjusting the screen to an optimal position for the user. As a result, improved readability of the screen is achieved while simplifying the use of the display system. Also, the display system of the present invention can be used by various types of users. For example, a retail employee can utilize the display system for restocking shelves, pulling items off shelves, or during inventory.

A display system is disclosed. The display system comprises a base, a screen movably coupled to the base, and a control unit coupled to the screen. The control unit adjusts the screen to a position based on at least one condition such that the need for a user to manually adjust the screen is eliminated. The at least one condition can be a user attribute such as height or eye position. A sensor can be utilized to detect at least one attribute and transmit the at least one attribute to the control unit. Alternatively, a memory unit can be used to store the at least one attribute and transmit the at least one attribute to the control unit. According to the system disclosed herein, the display system increases the convenience of a user by automatically adjusting the screen to an optimal position for the user. As a result, improved readability of the screen is achieved while simplifying the use of the display system.

Although the present invention has been described in accordance with the embodiments shown, one of ordinary skill in the art will readily recognize that there could be variations to the embodiments and those variations would be within the spirit and scope of the present invention. Embodiments of the present invention can be implemented using hardware, software, a computer readable medium containing program instructions, or combination thereof. Accordingly, many modifications may be made by one of ordinary skill in the art without departing from the spirit and scope of the appended claims.

What is claimed is:

1. A display system comprising:
a base;
a screen movably coupled to the base;
a control unit coupled to the screen, wherein the control unit adjusts the screen to a position based on at least one condition; and
a memory unit adaptably interoperable with the control unit, wherein the memory unit stores the at least one condition and transmits the at least one condition to the control unit and wherein the control unit adjusts the screen to at least one of a pre-set position, a re-adjusted pre-set position, or a default position determined in relation to the at least one condition.

2. The system of claim 1 wherein the at least one condition comprises at least one attribute.

3. The system of claim 2 wherein the at least one attribute comprises at least one of a height of an object, an eye position, and any combination thereof.

4. The system of claim 1 wherein the screen can be adjusted to track an object.

5. The system of claim 4 wherein the object can be a user, a customer, or an employee.

6. The system of claim 1 further comprising a sensor coupled to the control unit, wherein the sensor detects the at least one condition and transmits the at least one condition to the control unit.

7. The system of claim 6 wherein the sensor detects the presence of an object.

8. The system of claim 6 wherein the sensor detects a height of an object.

9. The system of claim 6 wherein a pupil location of the object is utilized to determine a height.

10. The system of claim 6 wherein the sensor detects an eye location of the user.

11. The system of claim 10 wherein the eye location is utilized to determine a height.

12. The system of claim 6 wherein the sensor can be at least one of an optical sensor, a proximity sensor, an ultrasonic sensor, a camera, and any combination thereof.

13. The system of claim 1 wherein the memory unit is a card.

14. The system of claim 1 wherein the screen is adjusted from the position to a second position when the display system is not in use.

15. The system of claim 1 wherein the screen can be locked into the position when the display system is not in use.

16. The system of claim 1 wherein the display system is adapted to mount onto a mobile unit.

17. The system of claim 16 wherein the mobile unit is a cart.

18. The system of claim 16 wherein the base is the mobile unit.

19. The system of claim 1 wherein the control unit adjusts the screen by rotating the screen.

20. The system of claim 1 wherein the control unit adjusts the screen by changing the angle of the screen.

21. The system of claim 1 wherein the control unit comprises:
a processor;
a motor coupled to the processor; and
gears coupled to the motor for adjusting the screen.

22. A shopping cart comprising:
a display system comprising:
a base;
a screen movably coupled to the base;
a control unit coupled to the screen;
a sensor coupled to the control unit, wherein the sensor is capable of detecting at least one user attribute and transmitting the at least one user attribute to the control unit, and
a memory unit adaptably interoperable with the control unit, wherein the memory unit is capable of storing at least one condition and transmitting the at least one condition to the control unit,
and wherein the control unit adjusts the screen to at least one of a pre-set position, a re-adjusted pre-set position, or a default position determined in relation to one or more of the at least one user attribute and the at least one condition.

23. The system of claim 22 wherein the at least one user attribute comprises at least one of a height, an eye position, and any combination thereof.

24. A computer readable medium containing program instructions for controlling a display system, the display system including a base, a screen, and a memory unit adaptably interoperable with a control unit, the program instructions which when executed by a computer system cause the computer system to execute a method comprising transmitting at least one condition to the control unit, and adjusting the screen to a position based on the at least one condition stored in the memory unit, wherein the control unit adjusts the screen to at least one of a pre-set position, a re-adjusted pre-set position, or a default position determined in relation to the at least one condition.

25. The computer readable medium of claim 24 wherein adjusting the screen is performed by utilizing a sensor.

26. The computer readable medium of claim 24 further comprising program instructions for storing the position.

27. The computer readable medium of claim 26 wherein storing the position is performed by utilizing a memory card.

28. The computer readable medium of claim 24 further comprising program instructions for adjusting the screen to a default position when the system is not in use.

29. The computer readable medium of claim 24 further comprising program instructions for locking the screen in the position.
